(19) United States
(12) Patent Application Publication
(10) Pub. No.: US 2007/0300154 A1
(43) Pub. Date: Dec. 27, 2007

(54) OLE simulator for chemical drawing programs

(76) Inventor: Frederick H. Bartlett, Hamilton, NJ (US)

Correspondence Address: PETER S. CANELIAS;LAW OFFICES OF PETER S. CANELIAS, 420 LEXINGTON AVENUE, SUITE 2148, NEW YORK, NY, 10170, US

(21) Appl. No.: 11/473,394

(22) Filed: Jun. 23, 2006

(51) Int. Cl. G06F 17/00

(52) U.S. Cl. 715/538; 715/530

(57) ABSTRACT

The invention is a method for the creation of documents containing chemical formulae such that users can edit chemical formulae from within a word-processing program. In a preferred embodiment, the invention allows Macintosh users of ChemDraw to enjoy the advantages of Object Linking and Embedding (OLE) currently available only to users of Windows®-based PCs. In its preferred form, the invention simulates, on Apple Macintosh computers, the action of the well-known OLE protocol operating on Microsoft® Windows systems.

### BACKGROUND OF THE INVENTION

The invention is an interactive computer system for the creation of documents containing chemical formulae such that users can edit chemical formulae from within a word-processor. In a preferred embodiment, the invention allows Macintosh users of ChemDraw to enjoy the advantages of Object Linking and Embedding (OLE) currently available only to users of Windows-based personal computers (PCs). In its preferred form, the invention simulates, on Apple Macintosh computers running Mac OS or Mac OS X, the action of the well-known OLE protocol operating on Microsoft® Windows systems. The formulae remain in drawing program compliant form, but the graphical representations in the word processing program are dynamically rendered from the chemical drawing program sources. In other words, the formulae are “smart graphics” with all the chemical information still accessible, rather than “dumb graphics” which could only be manipulated by a graphics program such as Photoshop, with no awareness of the chemistry.

A chemical drawing program allows chemical information to be manipulated, stored and searched as computer data by a computer. A chemical drawing program typically allows a user to cause chemical structural information and chemical reaction information to be displayed on a computer screen and printed out on paper as desired. If a user has chemical information in the application program that is relevant to another application program, the user typically can use the cut and paste capabilities of the application program to copy the relevant information to the other application program. If one of the application programs is a Web browser interacting with a Web server, the user typically can use the cut and paste capabilities to share information between the Web browser and the other application program, and can thereby, in a limited way, share information between the Web server and the other application program. However, existing chemically oriented application programs provide inadequate abilities to access and edit chemical information without cutting and pasting, and even then, full functionality is not available. This is because the chemical information is always and only resident in the file produced by the chemistry drawing program. Cutting and pasting from the drawing program to the word processor only copies the graphic representation of the chemical information. In order for all of the chemical information to be accessible from within another application, the chemical information file must be readable by that application.

Authors of documents in the field of chemistry wish to be able to edit both their text (preferably in Microsoft® Word version 8 or higher) and their chemical formulae (preferably in CambridgeSoft ChemDraw Ultra, version 6 or higher, available from CambridgeSoft Corporation, 100 Cambridge Park Drive, Cambridge, Mass. 02140 (www.cambridgesoft.com)). These programs are typically stored on a local computer hard drive or either a network file server or an application server, as those skilled in the art would appreciate.

It has not been possible edit both text and chemical formulae directly on Apple Macintosh computers for many years; instead, Apple Macintosh users could only paste graphical (and hence non-editable) representations of their chemical formulae into Microsoft® Word documents. It is possible to move chemical formulae between Microsoft® Word and CambridgeSoft ChemDraw by cutting and pasting, but one then loses the advantage of having separate named files for the chemical formulae (which can then be reused). The additional steps of selecting, cutting and pasting also allows the introduction of data errors through incomplete cutting and/or pasting.

In 1993, with the advent of Microsoft® Word 6 for the Macintosh, Microsoft® Corporation stopped supporting a protocol called Edit Graphic Object (EGO), which allowed dynamic linking to other application files from within Word. Thus, authors of chemical papers who wished to use a more recent version of Word were unable to edit their chemical formulae except by opening the file from the chemical drawing application (here preferably ChemDraw) and then manually cutting and pasting the graphic from ChemDraw to Word.

By contrast, a Windows user could simply double-click on the chemical formula in Word and edit it using ChemDraw's tools, the edited graphic appearing instantly in the Word file. When one considers that a chemistry document can hold thousands of different chemical formulae, the necessity of keeping track of all the ChemDraw filenames corresponding to all the chemical graphics in Word is a great burden on the user.

A word processor is a programming tool specifically adapted to the manipulation of text and graphical images and provides a rich programming environment using a number of tools and macros that are familiar to many users. As word processing functionality has improved, users familiar with the capabilities of their particular word processing program may become dependent on those functions.

An example is seen in U.S. Publication No. 20010047398 to Rubenstein, which states in paragraph [003] that: “If a user has chemical information in the application program that is relevant to another application program, the user typically can use the cut and paste capabilities of the application program to copy the relevant information to the other application program.” Another somewhat different example is disclosed in U.S. Publication No. 20050065733 to Caron et al., wherein the disclosure describes the following procedure: “(i) the structures were sketched into ChemDraw 6.0 (CambridgeSoft, Cambridge, Mass.); (ii) the sketched structures were highlighted; (iii) the highlighted structures were copied using the “Copy As SMILES” command from the Edit menu; and (iv) the SMILES string was pasted into a text file.” Note that the chemical structure of a chemical compound may be stored as a “simplified molecular input line entry specification” (SMILES) string, which is a particular comprehensive chemical nomenclature capable of representing the structure of a chemical compound using text characters, not graphical images. The graphical representations in drawing programs such as ChemDraw are much easier for chemists to understand. In sum, the prior art illustrates the use of cutting and pasting (or copying and pasting), with its attendant limitations, in contrast to the data linking function of the present invention, which links the data resident in the drawing program file to the graphical image incorporated into a word processing document.

### BRIEF SUMMARY OF THE INVENTION

The invention is a method, implemented by a tool in a computer system, which in its preferred form alleviates significant obstacles for writers dealing with chemical formulae, particularly that of inserting new chemical reactions into an existing table of reactions in a word processing program. While the ability to edit documents and chemical formulas are the functions of word processing programs such as Microsoft® Word and drawing programs such as CambridgeSoft ChemDraw, they have not been integrated on Apple Macintoshes since Microsoft stopped supporting EGO in 1993 with the release of Microsoft® Word 6 for the Macintosh. The new functionality of this invention simulates OLE so as to render ChemDraw formulae within the Microsoft® Word dynamic. The ChemDraw (Ultra and other versions) chemical drawing program is defined here as a proprietary drawing program. Microsoft® Word versions 6 and higher are defined here as proprietary word processing programs not having an edit, graphic object protocol compliant with a drawing program.

This tool provides a simple, streamlined method for users to integrate ChemDraw files into their Word document workflow, saving hours of traditional “cut and paste” work while increasing confidence in the accuracy of information through a seamless and simple interface. In particular, it allows users of ChemDraw to create and manage multi-page tables of reactions. Those skilled in the art will appreciate that any word processing program that includes a functional scripting language (VBA in the case of Word) with the capability of linking to AppleScript could function in accordance with the invention. The invention could also be configured to support OpenOffice or StarOffice. Among the features and benefits of this invention, the simulator, combined with the functionality of a word processing program, preferably Microsoft® Word, allows users to:

Pull formulae directly from the drawing program through easy to use dialog boxes and imbedded data retrieval commands in the word processor.

Leverage existing word processing templates and models.

View chemical formulae within a word processing program.

### The invention also provides for the following objects.

The invention enables drawing program data to be linked directly into word processing documents.

Documents no longer require data to be Copy and Pasted from other sources saving the user time and resources and reducing the possibility of error.

Drawings and formulae can be updated in real time.

Other objects and advantages will be more fully apparent from the following disclosure, including the drawings and appended claims.

### BRIEF DESCRIPTION OF THE DRAWINGS

The above-mentioned and other features and objects of this invention and the manner of obtaining them will become apparent and the invention itself will be best understood by reference to the following description of an embodiment of the invention taken in conjunction with the accompanying drawings, wherein:

FIG. 1 is block diagram of the apparatus for a preferred embodiment of the invention;

FIG. 2 is a typical display screen image for the installation, showing the selection of the OR_Table.dot template;

FIG. 3 is a display screen image, showing a confirmation dialog box;

FIG. 4 is a display screen image showing the enablement of the “Word Templates” in the drop-down list at the top of the file-open dialog box;

FIG. 5 is a display screen image showing the alternate installation of a document template;

FIG. 6 is a display screen image showing the selection of TextEq01.cdx to create a new document;

FIG. 7 is a display screen image showing a sample equation displayed in a word processing document.

### DETAILED DESCRIPTION

The invention consists of Visual Basic for Applications (VBA) code and AppleScript code embedded therein. The code adds context menu items to Microsoft® Word, using the standard Word VBA commands (CommandBars( ).Controls.Add( ), such that right- (or control-) clicking on a chemical formula in a Word document causes two new options to appear: Edit and Update. The functions are those supported by the operating system via OLE under Microsoft® Windows; this invention simulates at the application level what is usually done at the operating-system level.

When the user chooses Edit, ChemDraw is launched and the formula is loaded for editing from the linked ChemDraw file. ChemDraw files are typically designated with the file extension “.cdx”. Once the user has saved the edited formula, he then goes back to Word and chooses Update, which causes the graphical representation of the updated chemical formula to appear in the word processing document.

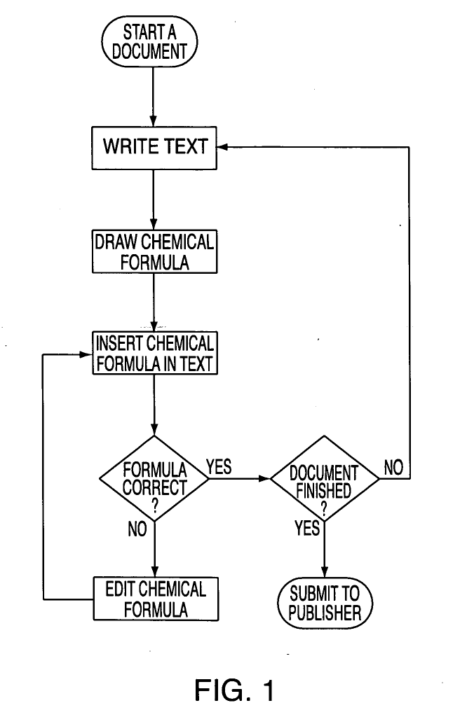

Reference is made to FIG. 1 showing the overall systemic architecture of a preferred embodiment of the invention. Here, the integration of VBA, AppleScript, and Word templates is essential; if any of the three elements were removed, the embodiment would fail to work. However, as those skilled in the art can appreciate, the technique disclosed herein could be adapted to any other pair of AppleScript-enabled applications.

The invention renders data, specifically here chemical formulae data and graphics, into a word processing program, preferably Microsoft® Word, via the “clipboard” in Word. As shown in FIG. 1, the overall architecture of the simulator comprises opening a document, writing text into the document, drawing a chemical formula and inserting a graphic representation of the chemical formula and a hidden link to the chemical formula's data file into the text of the document. Once the document is complete and correct, it is ready for storage and/or for transmission, usually to the publisher of the document. If the document is not yet finished, the user returns to the text-writing step within the document.

If any formula is not complete and correct, then the user edits and updates that formula to proceed again to the determination of whether all of the formulae are correct. If they are, then the user proceeds to the document finishing branch; if not, then the editing process is repeated.

Briefly, the preferred system is implemented as follows. The tools of the present system should be loaded correctly onto the user's computer. The Word and ChemDraw files are placed in a specified folder. All chemical images (reactions, structures) are added by clicking special menu buttons. Before saving the Word files for submitting via e-mail, disk or CD, the user clicks a special “hide graphics” button. Before submitting the files, the user compresses the file with standard software such as StuffIt or WinZip or burns them uncompressed onto a CD having sufficient disk space. To open a transmitted document file, the user clicks two special buttons: “update paths” then “restore graphics”.

The tools of the invention consist of the following three parts:

1. Word text tool (OR_Text.dot)

2. Word table tool (OR_Table.dot)

3. User's guide

### There are also tools available from ChemDraw which do not form part of the present invention, but may provide additional enhancements.

The tools are installed on a computer, preferably from a CD-ROM. When installing the tools, macros should be enabled, usually via a standard “Enable Macros” button in a Windows operating system dialog box. The install.doc file should be opened, and the “select and install a template” option selected from the screen. Selecting and installing a template will call up a standard Word file-open dialog box.

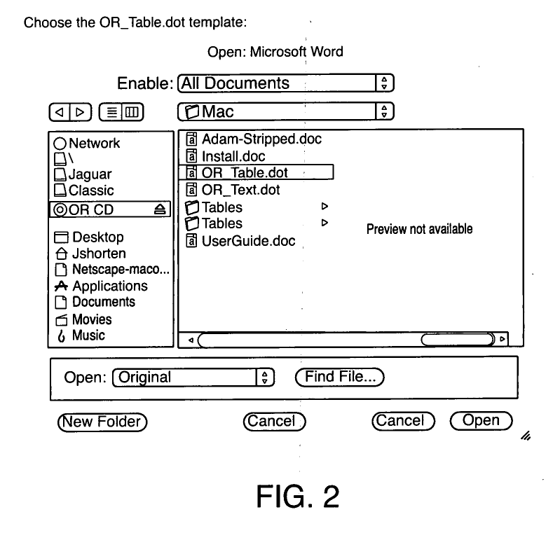

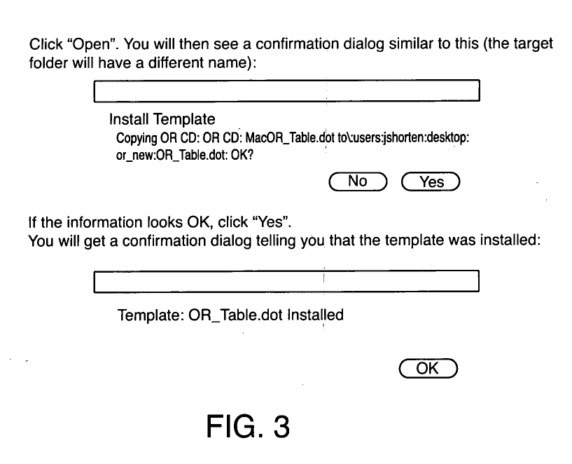

FIG. 2 shows a typical screen shot for the installation, showing the selection of the OR_Table.dot template. The user chooses the OR_Table.dot template and clicks “Open”. A confirmation dialog box is displayed, similar to that shown in FIG. 3. If the information shown is correct, including the target folder, the user clicks “yes” and a confirmation dialog will be displayed confirming installation of the template. This installation sequence is repeated for the OR_Text.dot template.

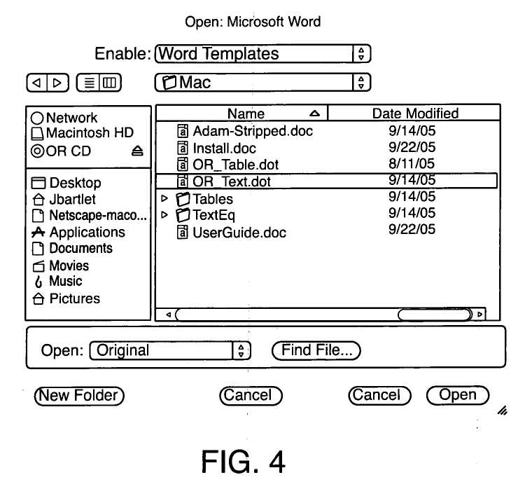

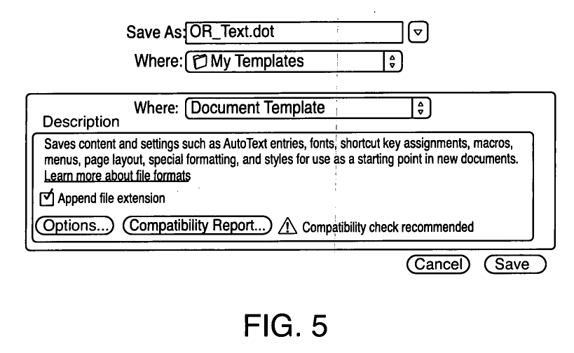

In the event of a failure to install properly, a user should open each template file and save it as a template. Template files can be opened by double-clicking on the file. Once saved, the template files may be opened using the “Word Templates” located in the drop-down list in the file-open dialog box. However, the user must enable “Word Templates” in the drop-down list at the top of the file-open dialog box, as shown in FIG. 4. The user then chooses a template, such as OR_Text.dot”, clicks “Open”, and then clicks through “File”|“Save As . . . ”. A dialog box similar to that shown in FIG. 5 will appear. The “Format” should be given as “Document Template” and the file should be saved in the appropriate location on the user's local hard drive or on a network drive or similar memory storage device. This process is repeated for the remaining file, here “OR_Table.dot”.

The user's guide is preferably saved to any convenient location in the memory of the computer or server. Any optional ChemDraw tools are installed according to their instructions. Once the installation is complete, the user may create a new document for use with the invention.

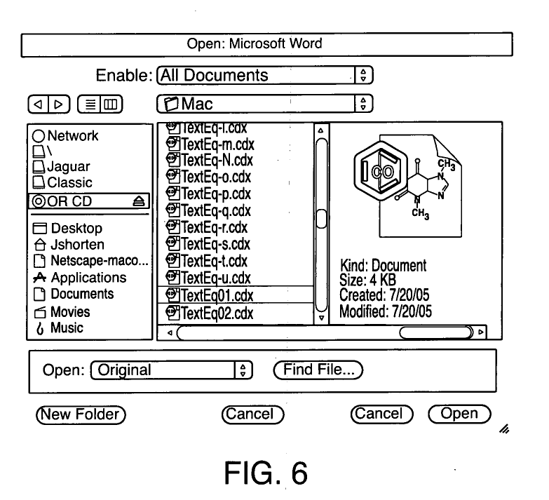

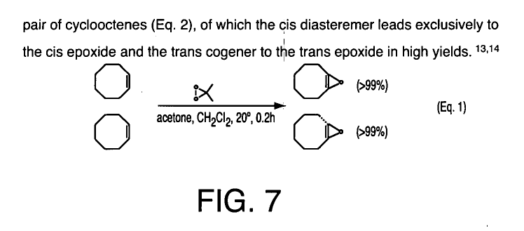

To create a new document, the user clicks “File” and then “Project Gallery . . . ”, chooses “My Templates”, and then double-clicks on “OR_Text.dot”. The user then clicks on the “Introduction” paragraph and types in the usual fashion until it is necessary to insert a chemical formula. The user then clicks through “OR”|“Insert|NumEq” and chooses a text equation from the file-open dialog box. FIG. 6 shows a screen shot of the selection of TextEq01.cdx. Choosing the file and clicking “Open” will bring up the stored chemical formula or reaction, as shown in FIG. 7.

To edit the formula, the user clicks on the formula once. A box with “handles” (8 black squares) will appear around the formula. Left-clicking inside that box and choosing “EditCdx” from the context menu will open the formula in ChemDraw for editing. The user then edits the formula and saves the ChemDraw file. The user then goes back to the Word window, and will view the formula unchanged (i.e., unedited). To update the file, the user left-clicks (or uses the Ctrl function) the formula and chooses “UpdateCdx” from the context menu. The old (unedited) graphic will be replaced with the edited graphic. The user may insert a numbered equation earlier in the file, which will cause the numbering to appear incorrect. When the user clicks through “OR”|“UpdateEqNums” the numbering will correct itself. To delete a reaction, the user places the cursor on the reaction and clicks through “OR”|“DeleteEq”.

The procedure is identical for all insertion buttons: InsertNumEq; InsertTextEq; InsertTable; and InsertScheme, which appear in a pull-down menu from the OR button on the Word toolbar. InsertTextEq inserts unnumbered chemical structures or reactions into the text. InsertNumEq inserts numbered chemical structures or reactions into the text, and equation numbers are generated automatically using Word autonumbering. InsertTable is not to be used in the text file, but only in the table file.

As is well known to those skilled in the art, all, or a portion, of the procedures described above may be implemented in hardware or software, or a combination of both. In at least some cases, it is advantageous if the technique is implemented in computer programs executing on one or more programmable computers, such as a personal computer running or able to run an operating system such as Microsoft Windows 98, 2000, XP or NT, or Macintosh OS (Mac OS or Mac OS X), that each include a processor, a storage medium readable by the processor (including volatile and non-volatile memory and/or storage elements), at least one input device such as a keyboard, and at least one output device. Program code is applied to data entered using the input device to perform the technique described above and to generate output information. The output information is applied to one or more output devices such as a display screen of the computer.

As is well known to those skilled in the art, each such computer program is stored on a computer readable medium or media (typically a storage medium or device), such as ROM or optical or magnetic disk or flash memory, that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A process of incorporating a graphical representation in a word-processing document and:
linking data located within a source file in a drawing program, comprising steps of:
opening the word-processing document within a word processing program, the word processing program not having an edit, graphic object protocol compliant with the drawing program;
creating the source file in the drawing program having the data and the graphical representation;
inserting the graphical representation into the word-processing document;
linking the data within the source file to the graphical representation within the word-processing document.

2. The process of claim 1, further comprising the step of editing within the word processing document the data located in the source file.

3. The process of claim 2, further comprising the step of updating the word processing document.

4. The process of claim 1, wherein the graphical representation is a chemical formula.

5. The process of claim 1, wherein the data within the source file is compliant with a proprietary drawing program.

6. The process of claim 1, wherein the word-processing document is compliant with a proprietary word processing program.

7. Computer readable medium including at least program code for incorporating a graphical representation in a word-processing document and linking data located within a source file in a drawing program, the computer readable medium comprising:
computer program code for opening the word-processing document within a word processing program, the word processing program not having an edit, graphic object protocol compliant with the drawing program;
computer program code for creating the source file in the drawing program having the data and the graphical representation;
computer program code for inserting the graphical representation into the word-processing document;
computer program code for linking the data within the source file to the graphical representation within the word-processing document.

8. The computer readable medium of claim 7, the word processing program comprising computer program code for editing within the word processing document the data located in the source file.

9. The computer readable medium of claim 8, further comprising computer readable code for updating the word processing document.

10. The computer readable medium of claim 7, wherein the graphical representation is a chemical formula.

11. The computer readable medium of claim 7, wherein the data within the source file is compliant with a proprietary drawing program.

12. The computer readable medium of claim 7, wherein the word-processing document is compliant with a proprietary word processing program.
